(19) United States
(12) Patent Application Publication
(10) Pub. No.: US 2013/0199242 A1
(43) Pub. Date: Aug. 8, 2013

(54) METHOD OF MANUFACTURING A LIQUID CRYSTAL DISPLAY ELEMENT

(71) Applicant: PANASONIC LIQUID CRYSTAL DISPLAY CO., LTD., Himeji-shi (JP)

(72) Inventors: Katsuto SUGIMOTO, Hyogo (JP); Takeharu URABE, Osaka (JP)

(73) Assignee: PANASONIC LIQUID CRYSTAL DISPLAY CO., LTD., Himeji-shi (JP)

(21) Appl. No.: 13/757,160

(22) Filed: Feb. 1, 2013

(30) Foreign Application Priority Data
Feb. 7, 2012 (JP) 2012-023696

(51) Int. Cl. C03C 15/00

(52) U.S. Cl. CPC C03C 15/00
USPC 65/31

(57) ABSTRACT

Provided is a method of manufacturing a liquid crystal display element, including: providing chases (5) on a surface (2a) of a glass substrate (2) at least in an entire area of a liquid crystal display element section (1); and subjecting the surface (2a) to chemical polishing.

### CROSS-REFERENCE TO RELATED APPLICATION

The present application claims priority from Japanese application JP 2012-023696 filed on Feb. 7, 2012, the content of which is hereby incorporated by reference into this application.

### BACKGROUND OF THE INVENTION

1. Field of the Invention

The present invention relates to a method of manufacturing a liquid crystal display element.

2. Description of the Related Art

In recent years, as a method of manufacturing a liquid crystal display element, there has been known a method of cutting a large-size glass substrate called a mother glass substrate to cut out each individual liquid crystal display element. Of such liquid crystal display elements, particularly with respect to a liquid crystal display element to be used in a portable information device, there are particularly strong needs for downsizing. Therefore, in such manufacturing of the liquid crystal display element, the glass substrate is desired to be polished to be thinned.

FIG. 7A is a plan view of a mother glass substrate 102 illustrated for each individual liquid crystal display element section 101, and FIG. 7B is a sectional view of the mother glass substrate 102, taken along the line VIIB-VIIB of FIG. 7A. A region of the mother glass substrate 102 for each liquid crystal display element section 101 is referred to as “glass substrate 102c.”

As a method of thinning the mother glass substrate 102, there is generally known a method of dissolving a surface 102a thereof with use of an etchant containing hydrofluoric acid as a main component (hereinafter referred to as “chemical polishing”).

### SUMMARY OF THE INVENTION

In a process of processing the mother glass substrate 102, spot-like (linear) flaws (hereinafter referred to as “microcracks”) 103a₁ and 103b₁ may be generated during the manufacturing steps. Further, due to a method of conveying the mother glass substrate 102 by a substrate lift pin (not shown) or the like, a dot-like microcrack 103c₁ may be generated in the mother glass substrate 102.

However, when the surface 102a is subjected to chemical polishing, if the linear microcracks 103a₁ and 103b₁ and the dot-like microcrack 103c₁ exist in the surface 102a, the etchant may act so that those microcracks are further enlarged.

In this case, the linear microcracks 103a₁ and 103b₁ become linear concave portions (hereinafter referred to as “dimples”) 103a₂ and 103b₂ as illustrated in FIGS. 8A and 8B. Further, the dot-like microcrack 103c₁ becomes a hemispherical dimple 103c₂. The dimples are generated as described above, and hence the flatness of the surface 102a of the mother glass substrate 102 is impaired. Therefore, there has been a problem in that, after the glass substrate 102c is cut out for each liquid crystal display element section 101, failure occurs in each individual liquid crystal display element.

To address such a problem that dimples are generated in the surface of the glass substrate during chemical polishing, there is disclosed a method in which, before chemical polishing, a fluoride is deposited in the microcracks by high-viscosity surface polishing liquid containing hydrofluoric acid, to thereby suppress growth of the dimples during chemical polishing.

However, in such a method, it is necessary to process the mother glass substrate by the surface polishing liquid before chemical polishing. Therefore, the substrate is liable to be affected by stain due to surface polishing and the like, and hence the number of steps for the pre-cleaning process and the processing time are increased.

The present invention has been made in view of the above-mentioned circumstances, and therefore has an object to provide a method of manufacturing a liquid crystal display element, which is capable of preventing generation of dimples without increasing the processing time.

In order to solve the above-mentioned problems, the present invention adopts the following configuration. That is, according to a first exemplary embodiment of the present invention, there is provided a method of manufacturing a liquid crystal display element including: providing chases in an entire area of a surface of a glass substrate of the liquid crystal display element ; and immersing the glass substrate into surface polishing liquid to subject the surface to chemical polishing.

Further, according to a second exemplary embodiment of the present invention, in the method of manufacturing a liquid crystal display element, it is preferred that the providing chases be carried out by sandblasting.

### BRIEF DESCRIPTION OF THE DRAWINGS

In the accompanying drawings:

FIG. 1A is a plan view of a mother glass substrate having microcracks;

FIG. 1B is a sectional view taken along the line IB-IB of FIG. 1A;

FIG. 2A is a plan view of the mother glass substrate provided with chases;

FIG. 2B is a sectional view taken along the line IIB-IIB of FIG. 2A;

FIG. 3 is an enlarged sectional view of the glass substrate after chemical polishing;

FIG. 4A is a plan view of the mother glass substrate after chemical polishing;

FIG. 4B is a sectional view taken along the line IVB-IVB of FIG. 4A;

FIG. 5 is an exploded perspective view of a liquid crystal display element according to an embodiment of the present invention;

FIG. 6 is a plan view of a schematic configuration of the liquid crystal display element according to the embodiment of the present invention;

FIG. 7A is a plan view of a conventional mother glass substrate having microcracks;

FIG. 7B is a sectional view taken along the line VIIB-VIIB of FIG. 7A;

FIG. 8A is a plan view of the conventional mother glass substrate after chemical polishing; and

FIG. 8B is a sectional view taken along the line VIIIB-VIIIB of FIG. 8A.

### DETAILED DESCRIPTION OF THE INVENTION

In the following, a method of manufacturing a liquid crystal display element according to the present invention is described with reference to the drawings. Note that, in some cases, the drawings referred to in the following description illustrate characteristic parts in an enlarged manner for the sake of easy understanding of the features, and the dimensional ratio and the like of each component need not be the same as those of the actual component. Further, the materials, dimensions, and the like exemplified in the following description are merely examples, and the present invention is not limited thereto. Modifications can be made as appropriate without departing from the gist of the present invention.

A method of manufacturing a liquid crystal display element 4 according to an embodiment of the present invention includes a step of providing chases 5 on a surface 2a of a glass substrate 2 at least in an entire area of a liquid crystal display element section 1, and a step of subjecting the surface 2a of the glass substrate 2 to chemical polishing. In the following, each step is described in detail.

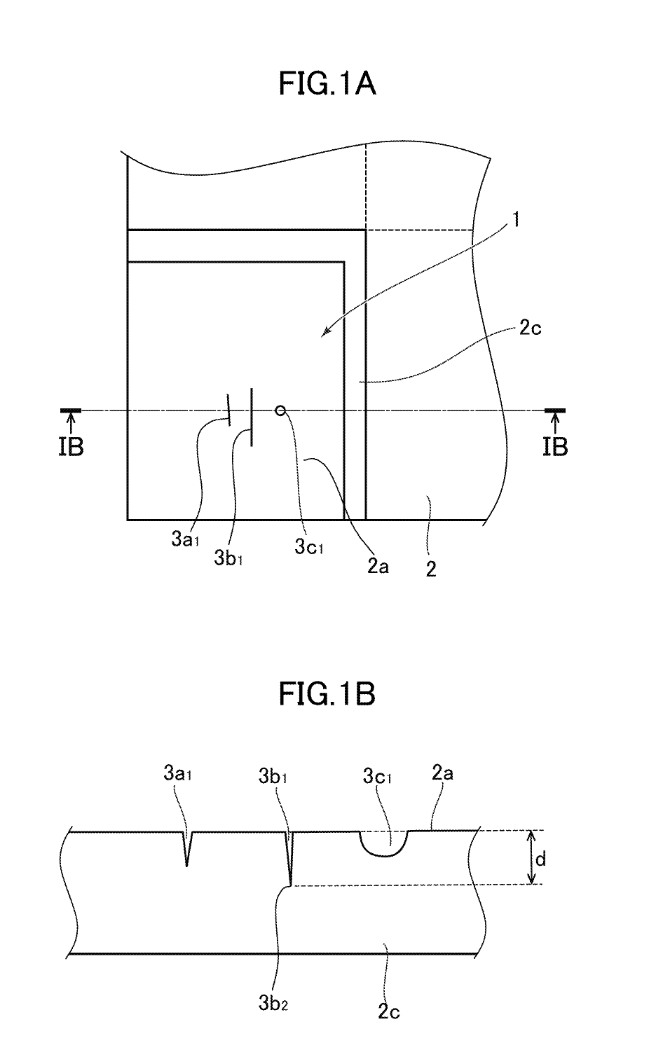

FIG. 1A is a plan view of the mother glass substrate 2 having microcracks, and FIG. 1B is a sectional view of the mother glass substrate 2, taken along the line IB-IB of FIG. 1A. In the following, the mother glass substrate 2 provided with microcracks 3a₁, 3b₁, and 3c₁ is described as an example.

As illustrated in FIG. 1A, the mother glass substrate 2 is sectioned for each individual liquid crystal display element section 1. A region of the mother glass substrate 2 sectioned for each liquid crystal display element section 1 is referred to as “glass substrate 2c.” Two mother glass substrates 2 are overlapped with each other, and liquid crystal (not shown) is sealed therebetween. Note that, in this embodiment, only one of the two mother glass substrates 2 is illustrated.

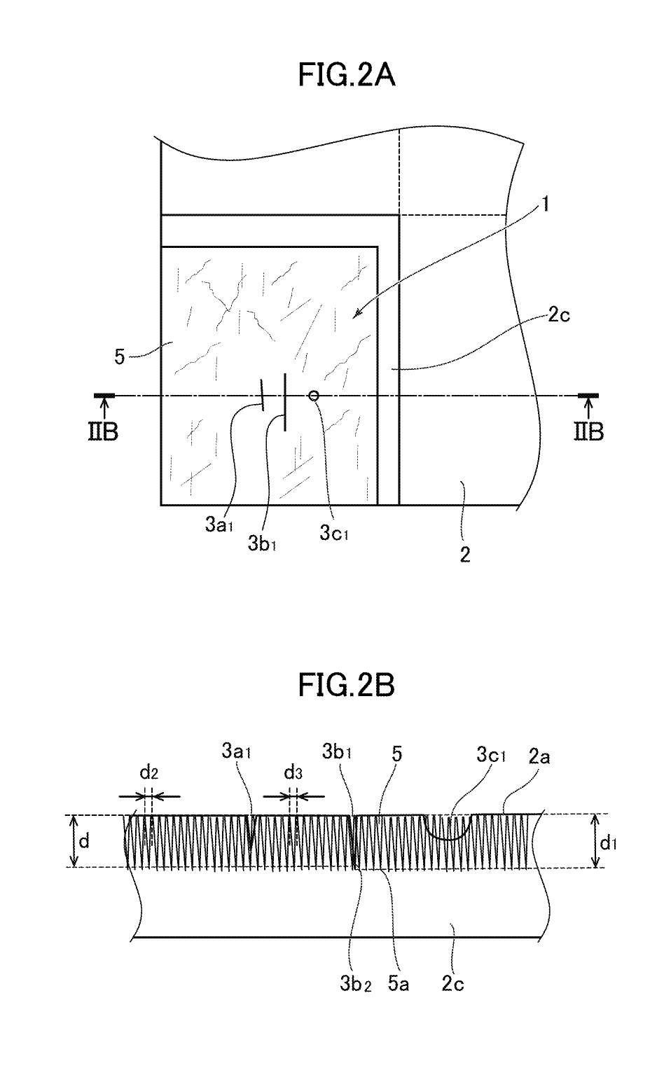

The linear microcracks 3a₁ and 3b₁ are generated, in a case where, for example, the mother glass substrate 2 is conveyed, when a conveyance lift pin or suction pad (not shown) or the like comes into contact with the surface 2a. Such microcracks 3a₁ and 3b₁ may have, for example, a shape in which dot-like concave portions are linearly continued, or a shape in which a groove-like concave portion is linearly extended. In this case, as illustrated in FIG. 2B, of the microcracks generated in the surface 2a, the microcrack 3b₁ has the largest depth d (d=distance from the surface 2a to a bottom portion 3b₂ of the microcrack 3b₁).

Further, the dot-like microcrack 3c₁ is generated, in a case where, for example, the mother glass substrate 2 is carried in and conveyed by a carry-in device such as a lift pin for substrate conveyance, when the surface 2a is supported by a support part of the carry-in device. Such a microcrack 3c₁ has a concave shape, and is scattered in a dot manner. Note that, the microcracks provided in the surface 2a are not limited to have those shapes, and may be general recesses generated in the surface 2a with an arbitrary shape, such as a scratched part, cracks, and chips.

FIG. 2A is a plan view of the mother glass substrate 2 provided with chases, and FIG. 2B is a sectional view taken along the line IIB-IIB of FIG. 2A. First, as illustrated in FIGS. 2A and 2B, the chases 5 are provided on the surface 2a of the glass substrate 2c at least in the entire area of the liquid crystal display element section 1. In this embodiment, the chase 5 refers to not a swell or a distortion of the glass substrate 2c or a chases provided during carry-in or conveyance, but a concave portion having a predetermined depth, which is provided by cutting a part of the surface of the glass substrate 2c by, for example, grinding the glass substrate 2c. Examples of the chase 5 include a scratch provided by, for example, polishing or grinding. Further, the chase 5 may have any shape such as a groove shape or a dot shape.

In this case, as illustrated in FIG. 2B, for example, the chases 5 each having a depth d₁ (d₁=distance between the surface 2a and a bottom portion 5a of the chase 5) are provided. At this time, in order that the depth d₁ of the chase 5 becomes equal to or larger than the depth d of the microcrack 3b₁, the grinding conditions are adjusted as appropriate by, for example, adjusting a particle diameter of an abrasive to be used for polishing (d₁≧d). Further, a width d₂ of the chase 5 is preferred to be smaller than the depth d₁ thereof (d₁>d₂). When the width d₂ is set smaller than the depth d₁, the flatness of the surface 2a after chemical polishing can be improved. Further, a gap d₃ between adjacent chases 5 is preferred to be equal to or smaller than the depth d₁. It is preferred that the value of the gap d₃ be as small as possible.

Further, a method of providing the chases 5 is not particularly limited as long as the method can provide chases with the uniform depth d₁. As such a method, sandblasting is particularly preferred, but other arbitrary polishing methods may be used, such as lapping, buffing, belt polishing, and laser polishing.

The chases 5 need not be provided parallel to each other in the entire area of the surface 2a of the liquid crystal display element section 1 as long as the gap d₃ between the adjacent chases 5 can be set equal to or smaller than the depth d₁. The chases 5 are preferred to be provided in random directions. When the chases 5 are provided in random directions, the flatness of the surface 2a after chemical polishing can be improved.

In this embodiment, the chases 5 need not be provided on the entire area of the surface 2a of the mother glass substrate 2, and the chases 5 may be provided on the surface 2a only in the liquid crystal display element section 1 which corresponds to the desirable number of liquid crystal display elements to be formed.

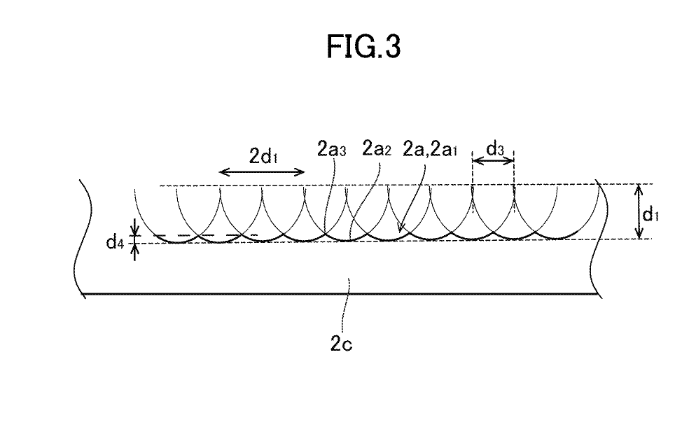

Subsequently, the surface 2a of the glass substrate 2c is subjected to chemical polishing. Examples of the method of the chemical polishing include a method of immersing the mother glass substrate 2 into surface polishing liquid (not shown). FIG. 3 is an enlarged sectional view of apart of the glass substrate 2c after chemical polishing. With the chemical polishing, the etchant acts so that the microcracks 3a₁, 3b₁, and 3c₁ and the individual chases 5 are further enlarged. In this embodiment, the depth of the chase 5 is set to the depth d₁, and hence as illustrated in FIG. 3, the individual chases 5 each become a groove-like dimple having the depth d₁ and a diameter 2d₁. Each of those dimples is joined to adjacent dimples, and hence there is formed a substantially flat surface 2a₁ having an assembly of curved-surface shaped bottom portions 2a₂ of the dimples.

As illustrated in FIG. 3, the bottom portion 2a₂ is formed for every chase 5, and hence the gap between adjacent bottom portions 2a₂ becomes d₃. A border between adjacent bottom portions 2a₂ is referred to as “boundary 2a₃.” The bottom portion 2a₂ has a curved surface, and hence as the gap d₃ corresponding to the gap between the adjacent bottom portions 2a₂ is shorter, a height d₄ from the bottom portion 2a₂ to the boundary 2a₃ becomes smaller. In this embodiment, the gap d₃ is set to be equal to or smaller than the depth dₗ, and hence the height d₄ of the boundary 2a₃ is suppressed, and the surface 2a (surface 2a₁) with high flatness can be formed.

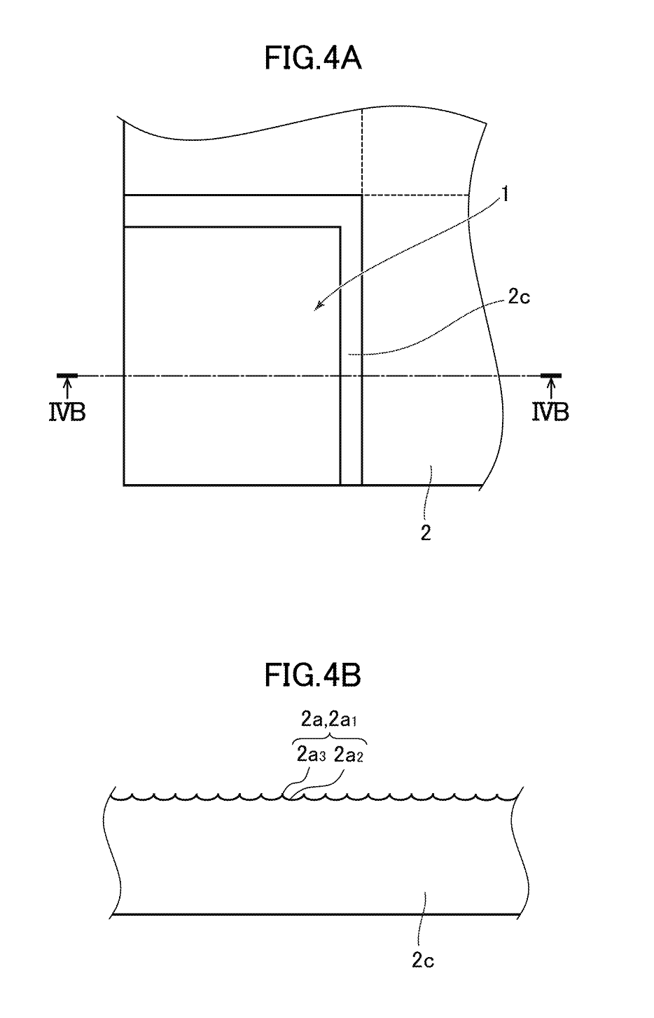

FIG. 4A is a plan view of the mother glass substrate 2 after chemical polishing, and FIG. 4B is a sectional view taken along the line IVB-IVB of FIG. 4A. As illustrated in FIGS. 4A and 4B, generation of dimples in the surface 2a of the glass substrate 2c is suppressed, and the surface 2a becomes a substantially flat surface.

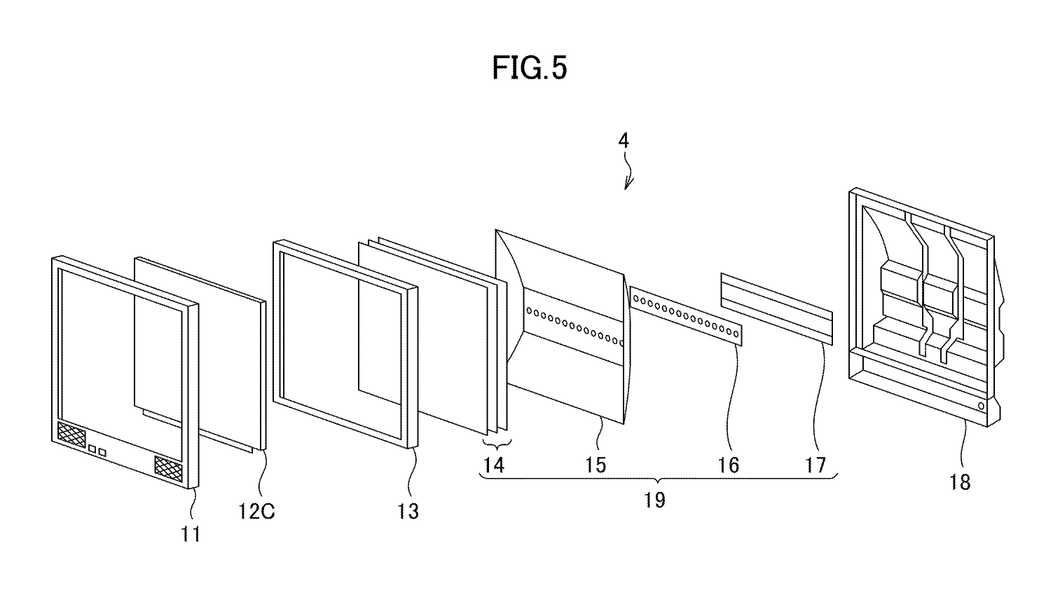

After that, the glass substrate 2c is cleaned, and the surface polishing liquid is completely removed. Subsequently, the mother glass substrate 2 is cut for each liquid crystal display element section 1, and each individual glass substrate 2c is cut out. After that, as illustrated in FIG. 5, an upper frame 11, a glass substrate (liquid crystal panel) 12C, an intermediate frame 13, an optical sheet group 14, a reflective sheet 15, a light emitting diode substrate 16, a radiator plate 17, and a lower frame 18 are arranged in the stated order to be assembled. In this manner, the liquid crystal display element 4 is manufactured. Note that, the optical sheet group 14, the reflective sheet 15, the light emitting diode substrate 16, and the radiator plate 17 form a backlight unit 19. The backlight unit 19 functions as a planar light source for illuminating the liquid crystal panel 12C from a rear surface side. Note that, FIG. 5 only illustrates the components of the liquid crystal display element 4, and illustration of other components, such as a control board and a speaker, is omitted.

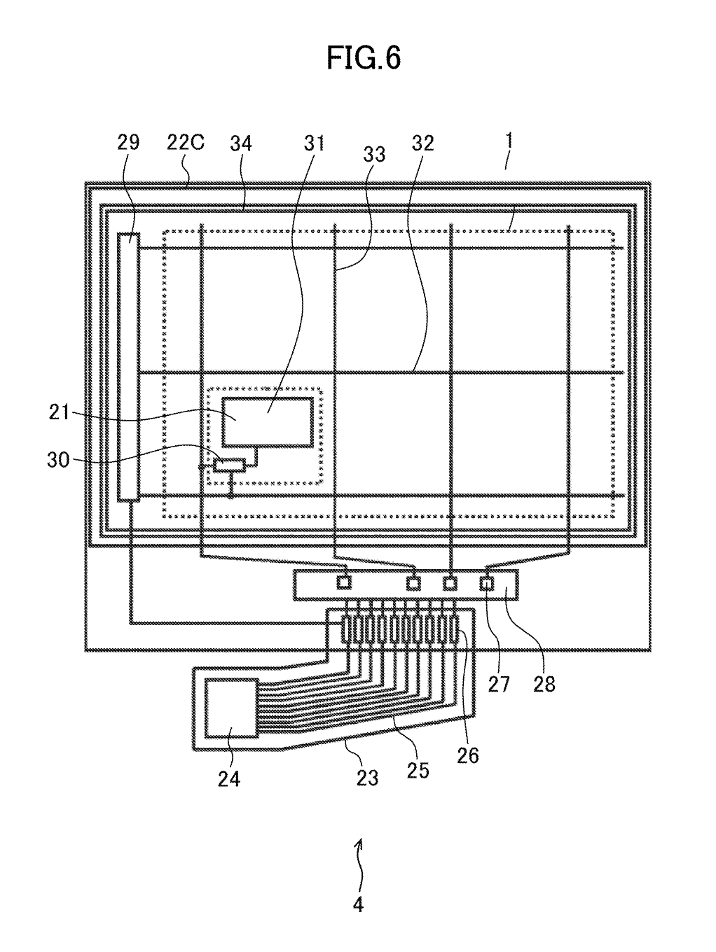

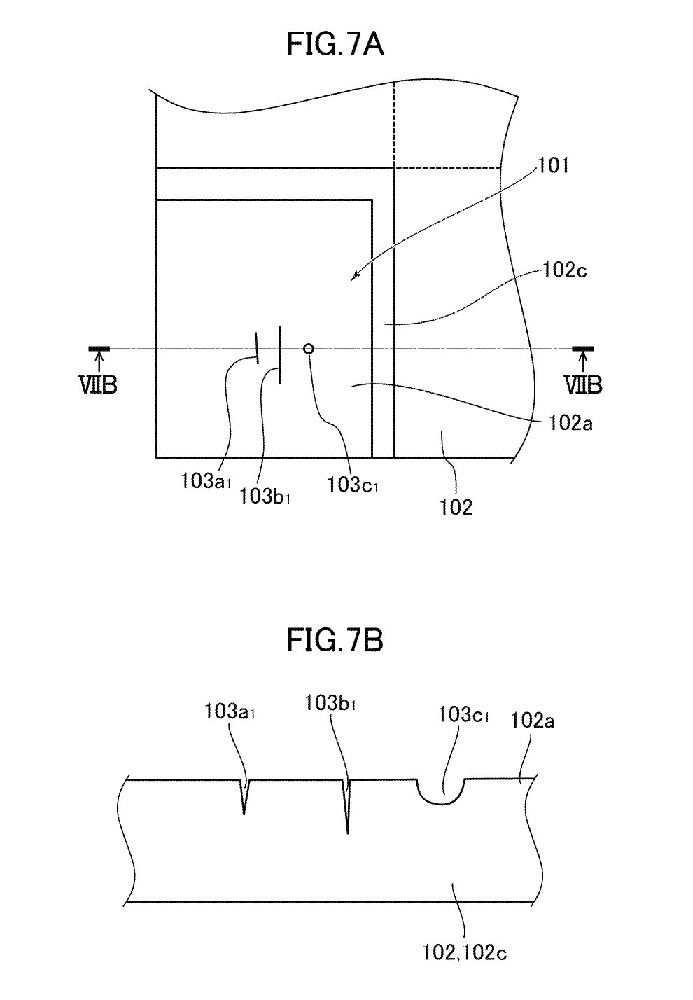

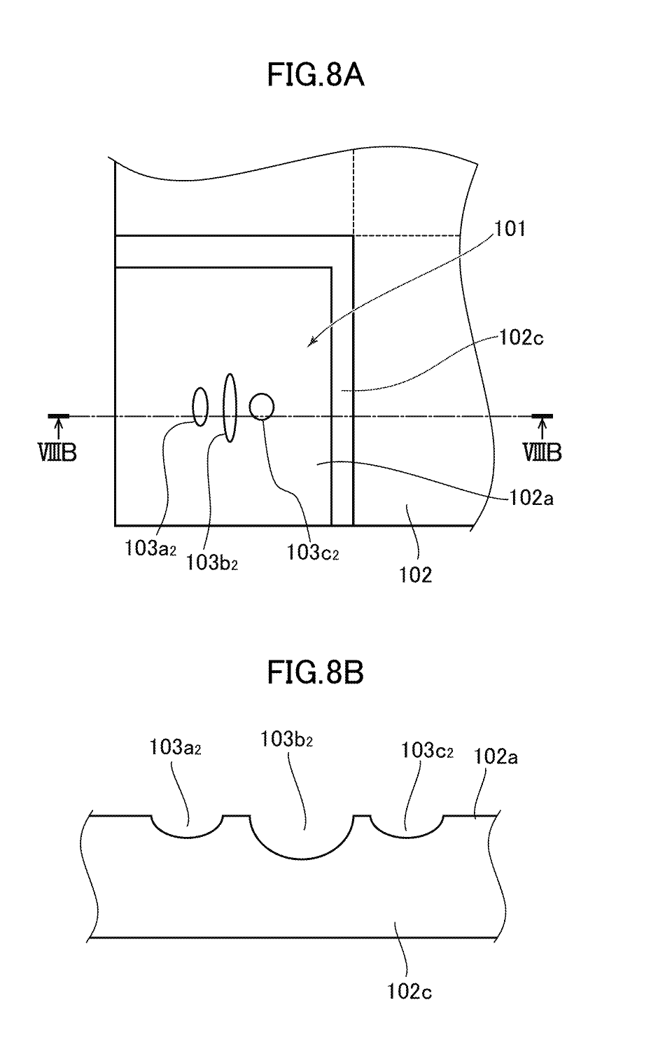

In this manner, as illustrated in FIG. 6, there is formed the liquid crystal display element 4 including a glass substrate 22C including pixel portions 21 arranged in matrix, a control circuit 24 mounted to a flexible substrate 23, wiring 25, terminals 26, connection terminals 27, and drive circuits 28 and 29. Note that, the pixel portion 21 forms the liquid crystal display element section 1. Further, the pixel portion 21 includes a switching element 30 and a pixel electrode 31. The periphery of the pixel portion 21 is surrounded by gate signal lines 32 and drain signal lines 33.

Further, a sealing member 34 is provided on the outer periphery of the liquid crystal display element section 1 so that the two glass substrates 22C are adhered so as to be opposed to each other. The glass substrates 22C and the sealing member 34 form a shape of a container having a fine gap, and a liquid crystal composition is kept therein.

In this embodiment, before chemical polishing, the chases 5 each having the depth d₁ that is equal to or larger than the depth d of the microcrack 3b₁ are provided on the surface 2a of the glass substrate 2 at least in the entire area of the liquid crystal display element section 1. With this, each of the individual chases 5 becomes a groove-like dimple having the depth d₁ and the diameter 2d₁ through chemical polishing. Therefore, by providing the chases 5 so that the gap d₃ therebetween is equal to or smaller than the depth d₁, adjacent dimples are joined to each other. Thus, the substantially flat surface 2a₁ having an assembly of the bottom portions 2a₂ of the dimples is formed. Therefore, it is possible to prevent local generation of a dimple having a certain depth in the surface 2a₁, and it is possible to prevent occurrence of failure of the liquid crystal display element 4 due to the dimple.

Further, the chases 5 are provided in the entire area of the liquid crystal display element section 1 of the surface 2a. Therefore, as compared to the conventional method, the etching speed of the surface 2a can be increased. Therefore, the processing time for chemical polishing can be shortened. Further, the processing time for chemical polishing can be shortened, and hence the damage to be applied to the surface 2a by chemical polishing can be reduced. As a result, the quality of the liquid crystal display element 4 can be improved.

Further, as the method of providing the chases 5, it is preferred to mainly adopt sandblasting. With this, the chases 5 can be provided uniformly in the surface 2a. Therefore, through chemical polishing, the glass substrate having the surface 2a₁ with high flatness can be formed. Thus, the quality of the liquid crystal display element 4 can be improved.

In this embodiment, the chases 5 are provided on the surface 2a of the mother glass substrate 2 only in the liquid crystal display element section 1 which corresponds to the desirable number of liquid crystal display elements to be formed. In this manner, the glass substrate 2c can be formed to have different thicknesses for respective liquid crystal display element sections 1 through single chemical polishing. Further, the chases 5 are provided only in the liquid crystal display element section 1 in which the generation of dimples is predicted, and hence without performing polishing processing in the entire area of the mother glass substrate 2, it is possible to prevent occurrence of failure of the liquid crystal display element 4 due to the dimple.

The present invention has been described above by means of embodiments, but the present invention is not limited to the above-mentioned embodiments, and various modifications can be made thereto. For example, the structures described in the embodiments may be replaced by substantially the same structure, a structure which has the same action and effect, or a structure which can achieve the same object.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A method of manufacturing a liquid crystal display element, the method comprising:
providing chases on a surface of a glass substrate at least in an entire area of a liquid crystal display element section; and
subjecting the surface to chemical polishing with surface polishing liquid.

2. The method of manufacturing a liquid crystal display element according to claim 1, wherein the chases each have a depth that is equal to or larger than a depth of a microcrack to be formed when the glass substrate is conveyed.

3. The method of manufacturing a liquid crystal display element according to claim 1, wherein the chases each have a width that is smaller than a depth of a corresponding one of the chases.

4. The method of manufacturing a liquid crystal display element according to claim 1, wherein a gap between adjacent chases is equal to or less than a depth of a corresponding one of the chases.

5. The method of manufacturing a liquid crystal display element according to claim 1, wherein the providing chases is carried out by one of sandblasting, lapping, buffing, belt polishing, and laser polishing.
